(19) United States
(12) Patent Application Publication
(10) Pub. No.: US 2007/0189512 A1
(43) Pub. Date: Aug. 16, 2007

(54) Method and apparatus for processing stream encryption/decryption

(76) Inventor: Chiou-Haun Lee, Taichung City (TW)

Correspondence Address: CHARLES E. BAXLEY, ESQ., 90 JOHN STREET, THIRD FLOOR, NEW YORK, NY, 10038, US

(21) Appl. No.: 11/336,749

(22) Filed: Jan. 20, 2006

(51) Int. Cl. H04L 9/28; H04L 9/00; G06F 12/14; H04L 9/32; H04K 1/00; G06F 11/30

(52) U.S. Cl. 380/28; 713/189; 380/42

(57) ABSTRACT

This invention discloses a method and an apparatus for processing stream encryption/decryption and more particularly to a diffusion operation of a matrix of at least one dimension including a displacement and an exclusion or (XOR), so that a plurality of diffused starting positions is converted into a diffused function operation for quickly and continuously performing an XOR operation with a plaintext (or ciphertext) stream to generate a ciphertext (or plaintext) stream.

### BACKGROUND OF THE INVENTION

1. Field of the Invention

The present invention relates to a method and an apparatus for processing stream encryption/decryption by a diffusion mechanism, and more particularly to a diffusion operation for a matrix of at least one dimension including a displacement and an exclusion or (XOR), so that a plurality of diffused starting positions is converted into a diffused function operation for quickly and continuously performing an XOR operation with a plaintext (or ciphertext) stream to generate a ciphertext (or plaintext) stream.

2. Description of the Related Art

Prior art stream encryption/decryption method and apparatus use a random code generator to output a numeric value to a register, and the bits in the register are taken out constantly to perform an XOR with a plaintext stream to generate a ciphertext stream by the operations of linear or non-linear combination function and the shifts of register. Similar process is applied to the ciphertext to obtain the plaintext stream. The key point of safety of the prior art emphasizes on the linear complexity of a combination function so as to produce a large non-correlation with the bitstream taken out from the register and reduce the risk of breaking the combination function.

### SUMMARY OF THE INVENTION

To overcome the issue of stream correlation produced by the prior art, the present invention uses an operation of a diffusion mechanism to represent a position by a linear function, and all position combinations are represented by a diffusion function, so that the maximum recurring period and linear complexity are reflected in the diffusion function to replace the prior art non-linear combination function and random code generator.

The technical measures taken to overcome the foregoing problem by the present invention are described as follows:

A diffusion mechanism that needs to repeat the diffused operations of a plurality of diffused starting positions has a fast operating speed in that the hardware design of the diffusion function can simultaneously complete the operations at a time. The diffusing mechanism also has a maximum recurring period and linear complexity for controlling the plurality of diffused starting positions, and the diffusion mechanism comprises the following steps:

(a) Select a diffused area of at least one dimension.

(b) The diffused area includes a plurality of diffused starting positions and at least one output position.

(c) The diffused starting position includes a starting position and an ending position.

(d) Output a trigger signal, and the trigger signal ∈ {0,1}.

(e) Execute a diffused operation of at least one dimension sequentially from the starting position to the ending position, and this step is carried out for at least one time; and

(f) The output position outputs a bit.

The effects of the present invention are compared with those of the prior art as follows. In prior art stream encryption/decryption method and apparatus, the internal random code generator controls the random codes to produce a maximum recurring period, and the internal non-linear combination function controls each segment of the output streams to produce a minimum correlation. However, if the non-linear combination function is broken, the stream cipher/decipher will become useless.

In the stream encryption/decryption method and apparatus of the present invention, the diffusion function determines the correlation between the maximum recurring period and the output stream. Unlike the non-linear combination function, the diffusion function is opened to the public, and thus even if the content of the internal register is broken, the present invention can be used again by resetting the content of the register.

### BRIEF DESCRIPTION OF THE DRAWINGS

FIG. 1 is a schematic view of the hardware layer of a diffusion mechanism according to the present invention; and

FIG. 2 is a schematic view of the hardware layer of a diffusion module according to the present invention.

### DETAILED DESCRIPTION OF THE PREFERRED EMBODIMENTS

The stream encryption/decryption method and apparatus of the present invention uses a diffused operation to form a diffusion mechanism, and at least one combination of the diffusion mechanism forms a diffusion module that comprises:

A diffused operation, for returning the value of the diffused area to the original value for every period of diffusions, as to the recurring period of diffusion. Therefore, there are two types of diffusion operations: a diffusion operation at a state after diffusion from the start to the end of a cycle, or a diffused operation at a state before diffusion from the end to the start of the diffusion.

The state after diffusion includes a diffused area, and the diffused area includes a diffused starting position, and an XOR operation is performed for the new value of the diffused starting position with a trigger signal, and the starting position is used as the diffusion center, and the diffusion direction is from the inside to the outside sequentially. The new value produced in the diffused area is an original value performing an XOR operation with the new value at an internal adjacent position until the entire diffused area is completed.

The state before diffusion includes a diffused area, and the diffused area includes a diffused starting position, and the starting position is used as the diffusion center, and the diffusion direction is from the outside to the inside sequentially. The new value produced in the diffused area is an original value performing an XOR operation with the original value at the internal adjacent position until the entire diffused area is completed, and the new value of the diffused starting position is obtained by performing an XOR operation for the original value with the trigger signal.

Symbols and Definition of Diffusion:

S is a diffused area with a m-dimensional matrix comprising a combination of n positions, m>0; n>0, and the position label is shown below:

For example, (a) one-dimensional S

| | | | | | |
|---|---|---|---|---|---|
| 1 | 2 | 3 | . . . | n-1 | n |

(b) Two-dimensional S

| | | | |
|---|---|---|---|
| 1 | 5 | . | n-3 |
| 2 | 6 | . | n-2 |
| 3 | 7 | . | n-1 |
| 4 | 8 | | n |

S(i): S uses the position i as the diffused starting position to execute the diffused operation.

$${S ( {i}_{1} , {i}_{2} , Λ , {i}_{k} )}_{i \to j} \text{:} S$$

S uses {i₁,i₂,Λ,iₖ|1≦iₖ≦n} sequentially as the diffused starting positions, and the set uses the position i as the starting position and the position j as the ending position to sequentially execute the diffused operation.

For example,

$$S {( 1 \text{:} n )}_{i \to i - 1} \text{:} S \qquad ( a )$$

S uses the positions 1 to n sequentially as the diffused starting positions, and the position i is the starting position, and the position i−1 is the ending position to sequentially execute the diffused operation.

$${S ( 1 \text{:} n )}_{i \to i} = [ {S ( 1 \text{:} n )}_{i \to i - 1} ] ( i ) \qquad ( b )$$

Sₜ is a diffusion mechanism for executing the operation of

$${S ( {i}_{1} , {i}_{2} , Λ , {i}_{k} )}_{i \to j}$$

for t times.

For example, (a) Sₜ=[Sₜ₋₁]₁ (b) S₂=[S₁]₁ (c) S₀=S

Sₜ_{₁}ₓₜ_{₂} executes the operation of Sₜ_{₂} for t₁ times.

For example, (a) Sₜ_{₁}ₓₜ_{₂}=[S₍ₜ_{₁}₋₁₎ₓₜ_{₂}]ₜ_{₂} (b) S_{2×2}=[S_{1×2}]₂=S₄ (c) S_{0×2}=S₀=S

F is a m+1 dimensional matrix f representing n positions of S.

Fₜ is a diffusion function for executing the operation of S₁ for t times and the linear function combination of n positions.

For example, (a) Fₜ=[Fₜ₋₁]₁ (b) F₂=[F₁]₁ (c) F₀=F

Sₜ_{₁}(Fₜ_{₂}) is an operation of Sₜ_{₁} by Fₜ_{₂}, and n positions produce a new value.

For example, (a) S₂=S₁(F₁), (b) S₁=S(F₁), (c) S=S(F), (d) Sₜ=Sₜ_{₁}ₓₜ_{₂}=S₍ₜ_{ᵢ}₋₁₎ₓₜ_{₂}(Fₜ_{₂})

T is a m-dimensional zero matrix, indicating that the values of n positions have no inverse phase.

Tₜ is a trigger area having a trigger signal of 1 for executing the operation of S₁ for t times, and the new value produces a position of a reverse phase.

For example, (a) Tₜ=Tₜ₋₁(F₁)⊕T₁ (b) T₂=T₁(F₁) ⊕T₁ (c) T₀=T (d) Tₜ=Tₜ_{₁}ₓₜ_{₂}=T₍ₜ_{ᵢ}₋₁₎ₓₜ_{₂}(Fₜ_{₂})⊕Tₜ_{₂}

The embodiments of a diffusion module are described below.

To make it easier for our examiner to understand the content of the present invention, the diffused operation, diffusion mechanism, diffusion function, trigger area, software design, and hardware design are described in details as follows:

Set a one-dimensional diffused area S comprised of 4 positions labeled as 1, 2 , 3 and 4, and

$${S}_{1} = {S ( 1 \text{:} 4 )}_{1 \to 4} .$$

The diffused operation uses 1 as the diffused starting position for the operation as shown in Table 1.

TABLE 1

| Diffused Stream | | | | |
|---|---|---|---|---|
| S | State After Diffusion | | State Before Diffusion | |
| 1 | i. | 1 = 1 ⊕ Tr | i. | 4 = 4 ⊕ 3 |
| 2 | ii. | 2 = 2 ⊕ 1 | ii. | 3 = 3 ⊕ 2 |
| 3 | iii. | 3 = 3 ⊕ 2 | iii. | 2 = 2 ⊕ 1 |
| 4 | iv. | 4 = 4 ⊕ 3 | iv. | 1 = 1 ⊕ Tr |

Tr: trigger signal
⊕: XOR

Diffusion mechanism:

$${S}_{1} = {S ( 1 \text{:} 4 )}_{1 \to 4} ,$$

and executes the diffused operation at the state before diffusion S₁. The relation of an operation of a diffused starting position corresponding to a new value produced for each position is shown in Table 2.

TABLE 2

| S | S = S(1) | S = S(2) | S = S(3) | S = S(4) |
|---|---|---|---|---|
| 1 | 1 | 2 | 1 | 1 ⊕ 2 ⊕ 3 |
| 2 | 1 ⊕ 2 | 1 ⊕ 2 | 2 ⊕ 3 | 1 ⊕ 2 |
| 3 | 2 ⊕ 3 | 1 ⊕ 3 | 1 ⊕ 3 | 2 ⊕ 4 |
| 4 | 3 ⊕ 4 | 2 ⊕ 4 | 1 ⊕ 2 ⊕ 3 ⊕ 4 | 1 ⊕ 2 ⊕ 3 ⊕ 4 |

⊕: XOR

Diffusion Function: Take F₇=F for example, the diffused operation at a state before diffusion is used. The diffusion function for six consecutive times is shown in Table 3.

TABLE 3

| S | F₁ | F₂ | F₃ | F₄ | F₅ | F₆ |
|---|---|---|---|---|---|---|
| 1 | 1 ⊕ 2 ⊕ 3 | 2 ⊕ 3 ⊕ 4 | 2 ⊕ 3 | 1 ⊕ 4 | 1 | 1 ⊕ 2 ⊕ 3 ⊕ 4 |
| 2 | 1 ⊕ 2 | 3 | 2 ⊕ 4 | 3 ⊕ 4 | 1 ⊕ 3 | 1 ⊕ 3 ⊕ 4 |
| 3 | 2 ⊕ 4 | 3 ⊕ 4 | 1 ⊕ 3 | 1 ⊕ 3 ⊕ 4 | 2 | 1 ⊕ 2 |
| 4 | 1 ⊕ 2 ⊕ 3 ⊕ 4 | 1 | 1 ⊕ 2 ⊕ 3 | 2 ⊕ 3 ⊕ 4 | 2 ⊕ 3 | 1 ⊕ 4 |

⊕: XOR

Trigger Area: The trigger signal is 0, and the new value of each position as shown by the diffusion function. The trigger signal is 1, and

$${T}_{1} = {T ( 1 \text{:} 4 )}_{1 \to 4}$$

repeats executing the diffused operation at the state before diffusion. The new value has a reverse phase as shown in the position labeled as 1 in Table 4.

TABLE 4

| S | T₁ | T₂ | T₃ | T₄ | T₅ | T₆ | T₇ |
|---|---|---|---|---|---|---|---|
| 1 | 1 | 1 | 1 | 0 | 0 | 1 | 0 |
| 2 | 0 | 1 | 0 | 1 | 1 | 1 | 0 |
| 3 | 1 | 0 | 0 | 0 | 1 | 1 | 0 |
| 4 | 1 | 0 | 1 | 1 | 1 | 0 | 0 |

Software Design of Diffusion Module:

Embodiment I: 16×1 diffusion module of S_{1×1}.

A plaintext is one-dimensional zero matrix.

A password is a 16-bit one-dimensional zero matrix.

Initialization:

1. The trigger signal is 1.

2. The passwords are entered sequentially into the diffused area.

3. The output position is the last bit of the diffused area.

4. S_{1×1}=S₁ outputs once for each operation.

$$5. {S}_{ 1} = {S ( 1 : 16 )}_{13 \to 13} .$$

Encryption Flow:

1. Sequentially obtain a bit from the plaintext stream.

2. The diffused area executes the operation of S₁, and the diffused area produces a new value.

3. Perform an XOR for the last bit in the diffused area with a bit of the plaintext stream.

4. Repeat the foregoing steps until the plaintext is finished.

Description:
S₀ [0000000000000000]
S₁ [1011001101100011]→Perform XOR for the last bit with a bit of the plaintext stream.
S₂ [0110100110110010]→Perform XOR for the last bit with a bit of the plaintext stream.
S₂_{¹⁶}₋₁ [0000000000000000]→Equal to S₀.
Results: (Take S₁ to S₆₄)
1011011100111011 (S₁ to S₁₆)
0000100100010111 (S₁₇ to S₃₂)
0100000011010100 (S₃₃ to S₄₈)
1011011111111110 (S₄₉ to S₆₄)

Embodiment II: 16×1 diffusion module of S_{1×2}.

A plaintext is a one-dimensional zero matrix.

A password is a 16-bit one-dimensional matrix.

Initialization:

1. The trigger signal is 1.

2. Enter the passwords sequentially into the diffused area.

3. The output position is the last bit of the diffused area.

4. S_{1×2}=S₂=[S₁]₁, and output once for every two operations.

$$5. {S}_{ 1} = {S ( 1 : 16 )}_{13 \to 13} .$$

Encryption Flow:

1. Take a bit sequentially from the plaintext stream.

2. The diffused area executes the operation of S₂, and the diffused area produces a new value.

3. Perform XOR for the last bit of the diffused area with a bit of the plaintext stream.

4. Repeat the foregoing steps until the plaintext is finished.

Description:
S₀ [0000000000000000]
S_{1×2} [0110100110110010]→Perform XOR for the last bit with a bit of the plaintext stream.
S_{2×2} [1001111000110101]→Perform XOR for the last bit with a bit of the plaintext stream.
S₍₂_{¹⁶}₋₁)×2 [0000000000000000]→Equal to S₀
Results: (Take S_{1×2} to S_{64×2})
0111010100010111 (S_{1×2}to S_{16×2})
1000111001111110 (S_{17×2} to S_{32×2})
1000010100011110 (S_{33×2} to S_{48×2})
1101011100000100 (S_{49×2} to S_{64×2})

Embodiment III is a 4×4 diffusion module of S_{1×1}.

A plaintext is a one-dimensional zero matrix.

A password is a 16-bit two-dimensional zero matrix.

The initialization and encryption flow are the same as those described in Embodiment I, but the diffusion mechanism is changed to

$${S}_{1} = {S ( 1 \text{:} 16 )}_{8 \to 8} .$$

Description:
S₀ [0000000000000000]
S₁ [1010001000100100]→Perform XOR for the last bit with a bit of the plaintext stream.
S₂ [1100000110010011 ]→Perform XOR for the last bit with a bit of the plaintext stream.
S₂_{¹⁶}₋₂ [0000000000000000]→Equal to S₀.

Results: (Take S₁ to S₆₄)
0111000100100111 (S₁ to S₁₆)
0000001100101011 (S₁₇ to S₃₂)
1110101001111110 (S₃₃ to S₄₈)
0011000001101100 (S₄₉ to S₆₄)

Hardware Design of Diffusion Module:

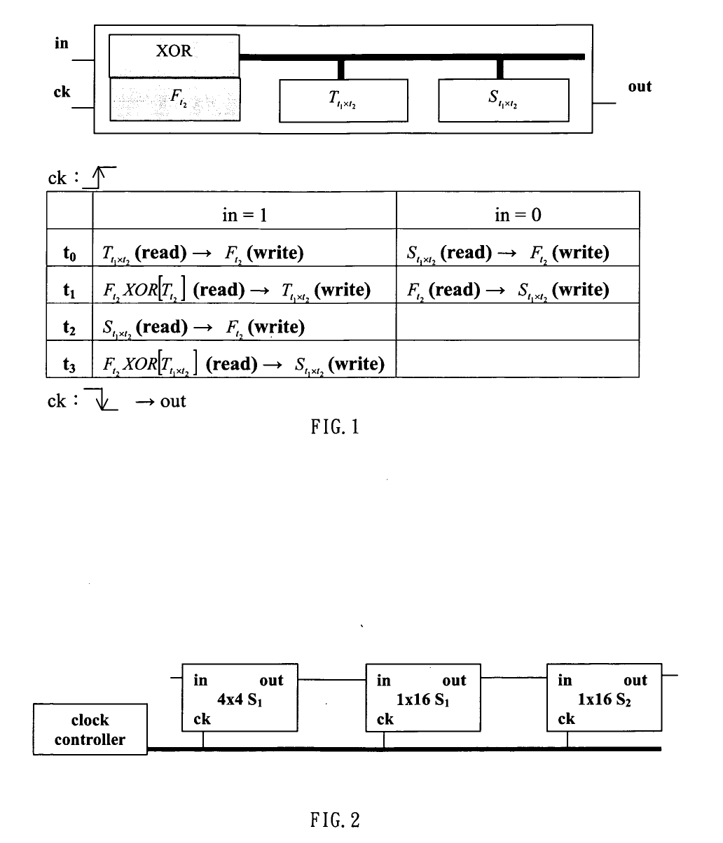

The operations of the Sₜ_{₁}ₓₜ_{₂} diffusion mechanism used for a software design are the operations of the Fₜ_{₂} diffusion function and the reverse phase of the Tₜ_{₂}, which are converted into a hardware design, and the synchronous operation of the hardware design obviously can reduce the time of forming streams as shown in FIG. 1.

Embodiment I: a 16×1 diffusion module of S_{1×2}.

$${S}_{1 \times 2} = {S}_{2} = {[ {S ( 1 \text{:} 16 )}_{13 \to 13} ]}_{1}$$

is converted into Fₜ_{₂}=F₂ and the linear function at each position is shown in Table 5.

TABLE 5

| | |
|---|---|
| f(1) | 1 ⊕ 3 ⊕ 5 ⊕ 7 ⊕ 9 ⊕ 13 |
| f(2) | 1 ⊕ 2 ⊕ 4 ⊕ 6 ⊕ 7 ⊕ 8 ⊕ 9 ⊕ 10 ⊕ 11 ⊕ 13 ⊕ 14 ⊕ 15 |
| f(3) | 1 ⊕ 9 |
| f(4) | 1 ⊕ 2 ⊕ 10 ⊕ 13 |
| f(5) | 3 ⊕ 5 ⊕ 11 ⊕ 14 ⊕ 15 |
| f(6) | 1 ⊕ 2 ⊕ 3 ⊕ 4 ⊕ 5 ⊕ 6 ⊕ 9 ⊕ 12 ⊕ 14 |
| f(7) | 9 ⊕ 13 |
| f(8) | 1 ⊕ 2 ⊕ 5 ⊕ 10 ⊕ 15 |
| f(9) | 2 ⊕ 9 ⊕ 11 ⊕ 13 |
| f(10) | 1 ⊕ 2 ⊕ 7 ⊕ 10 ⊕ 12 ⊕ 14 |
| f(11) | 1 ⊕ 2 ⊕ 5 ⊕ 9 ⊕ 13 ⊕ 15 |
| f(12) | 1 ⊕ 3 ⊕ 5 ⊕ 6 ⊕ 9 ⊕ 10 ⊕ 13 ⊕ 14 ⊕ 15 ⊕ 16 |
| f(13) | 3 ⊕ 7 ⊕ 9 ⊕ 11 ⊕ 13 ⊕ 14 ⊕ 15 ⊕ 16 |
| f(14) | 1 ⊕ 3 ⊕ 5 ⊕ 7 ⊕ 8 ⊕ 9 ⊕ 10 ⊕ 11 ⊕ 12 ⊕ 15 ⊕ 16 |
| f(15) | 3 ⊕ 4 ⊕ 7 ⊕ 8 ⊕ 9 ⊕ 10 ⊕ 11 ⊕ 12 |
| f(16) | 2 ⊕ 5 ⊕ 6 ⊕ 8 ⊕ 9 ⊕ 10 ⊕ 11 ⊕ 12 ⊕ 13 ⊕ 15 ⊕ 16 |

Tₜ_{₂}=T₂: 0110100110110010

Operation Flow:
in=1Tₜ_{₁}_{×2}=T₍ₜ_{₁}_{-1)×2}(F₂)⊕T₂, Sₜ_{₁}_{×2}=S₍ₜ_{_{1−1)×2}}(F₂)⊕Tₜ_{₁}_{×2}
in=0: Sₜ_{₁}_{×2}=S₍ₜ_{₁}_{-1)×2}(F₂)

Embodiment II: a 16×1 diffusion module of S_{1×1}.

$${S}_{1 \times 1} = {S}_{1} = {S ( 1 \text{:} 16 )}_{13 \to 13}$$

is converted into Fₜ_{₂}=F₁, and the linear function of each position is shown in Table 6.

TABLE 6

| | |
|---|---|
| f(1) | 1 ⊕ 7 ⊕ 9 ⊕ 11 |
| f(2) | 1 ⊕ 2 ⊕ 5 ⊕ 8 ⊕ 10 ⊕ 12 |
| f(3) | 5 ⊕ 7 ⊕ 9 ⊕ 11 |
| f(4) | 1 ⊕ 3 ⊕ 6 ⊕ 7 ⊕ 8 ⊕ 10 ⊕ 12 ⊕ 13 |
| f(5) | 1 ⊕ 3 ⊕ 5 ⊕ 9 ⊕ 11 ⊕ 13 |
| f(6) | 2 ⊕ 4 ⊕ 5 ⊕ 6 ⊕ 10 ⊕ 12 ⊕ 13 |
| f(7) | 1 ⊕ 3 ⊕ 9 ⊕ 11 |
| f(8) | 1 ⊕ 2 ⊕ 4 ⊕ 7 ⊕ 9 ⊕ 10 ⊕ 12 ⊕ 13 ⊕ 14 |
| f(9) | 3 ⊕ 7 ⊕ 11 ⊕ 13 ⊕ 14 |
| f(10) | 1 ⊕ 4 ⊕ 5 ⊕ 8 ⊕ 9 ⊕ 12 ⊕ 14 |
| f(11) | 1 ⊕ 3 ⊕ 5 ⊕ 7 ⊕ 9 ⊕ 11 ⊕ 14 |
| f(12) | 2 ⊕ 3 ⊕ 4 ⊕ 5 ⊕ 6 ⊕ 7 ⊕ 8 ⊕ 9 ⊕ 10 ⊕ 11 ⊕ |
| | 12 ⊕ 13 ⊕ 14 ⊕ 15 |
| f(13) | 1 ⊕ 14 ⊕ 15 |
| f(14) | 1 ⊕ 2 ⊕ 13 ⊕ 15 |
| f(15) | 2 ⊕ 3 ⊕ 14 ⊕ 16 |
| f(16) | 3 ⊕ 4 ⊕ 13 ⊕ 15 |

Tₜ_{₂}=T₁: 1011001101100011

Operation Flow:
in=1: Tₜ_{_{−1}}=Tₜ_{_{−1}}(F₁)⊕T₁, Sₜ=Sₜ₋₁(F₁)⊕Tₜ
in=0: Sₜ=Sₜ₋₁(F₁)

Embodiment III: a diffusion module of S_{1×t}_{₂} combination is shown in FIG. 2.

$$A 4 \times 4 , {S}_{1 \times 1} \text{:} {S}_{1} = {S ( 8 )}_{8 \to 8} . \\ A 16 \times 1 , {S}_{1 \times 1} \text{:} {S}_{1} = {S ( 13 )}_{13 \to 13} . \\ A 16 \times 1 , {S}_{1 \times 2} \text{:} {S}_{2} = {[ {S ( 13 )}_{13 \to 13} ]}_{1} .$$

Operation Flow:

A pulse controller controls the execution of three diffusion mechanisms by the pulse, and outputs a result of performing an XOR operation for a bit with a bit of the plaintext (or ciphertext) for the completed execution of every three diffusion mechanisms, and the diffusion module is executed repeatedly to produce a ciphertext (or plaintext) stream.

In the embodiments, the diffusion function can be used independently or expanded simply to one or more combinations, and the operation of the diffusion function is used to output the number of executions at the first bit, which can hardly compute the correlation. Furthermore, the value of a trigger area in each diffusion function for different combinations of the diffusion function cannot be known. Thus, the output value of the next bit cannot be found. In FIG. 2, a password is inputted from the “in end-point” into an internal register indirectly by the trigger signal method. Even if the content of the register can be guessed, the original password cannot be found, and the cipher still cannot be used. If a force breaking method is used, it is necessary to take 2ⁿ⁺¹ trials for an n-bit password.

While the invention has been described by means of specific embodiments, numerous modifications and variations could be made thereto by those skilled in the art without departing from the scope and spirit of the invention set forth in the claims.

What is claimed is:

1. A symmetric stream encryption/decryption method, comprising the steps of:
(a) selecting a diffusion module;
(b) inputting a password to said diffusion module;
(c) executing an operation of said diffusion module;
(d) performing an XOR with an output bit of said diffusion module and a plaintext or ciphertext stream bit; and
repeating steps (c) and (d) to generate a ciphertext or plaintext stream.

2. The method of claim 1, wherein said diffusion module comprises at least one diffusion mechanism.

3. The method of claim 2, wherein said diffusion mechanism comprises a plurality of combinations, and said combination defines a connecting method.

4. The method of claim 3, wherein said connecting method is a serial connection for sequentially starting said combination of said diffusion mechanism.

5. The method of claim 3, wherein said connecting method is a parallel connection for simultaneously starting said combinations of diffusion mechanism.

6. The method of claim 2, wherein said diffusion mechanism is an operation of a diffusion function F of a diffused area S, a trigger area T, and a trigger initial value T₀.

7. The method of claim 6, wherein said diffusion function F is a linear function set of at least one position of said diffused area, and the linear function of said position is an XOR equivalent operation of said at least one position.

8. The method of claim 6, wherein said-diffused area S has an operating value of Sₜ=Sₜ₋₁(F), t>0.

9. The method of claim 6, wherein said trigger area T has an operating value of Tₜ=Tₜ₋₁(F)⊕T₀, t>0.

10. The method of claim 9, wherein said diffused area S has an operating value of Sₜ=Sₜ₋₁(F)⊕Tₜ, t>0.

11. The method of claim 6, wherein said trigger initial value is T₀=0.

12. The method of claim 6, wherein said trigger initial value is T₀Tₜ₋₁(F), t>0.

13. The method of claim 6, wherein said password is inputted directly into said diffused area S.

14. The method of claim 2, wherein said diffusion mechanism is an operation of Sₜ, and said Sₜ executes
$$S {( {i}_{1} , {i}_{2} , Λ , {i}_{k} )}_{i \to j}$$
for t times, and comprises the steps of:
(a) selecting at least one-dimensional diffused area S;
(b) said diffused area including a plurality of diffused starting positions (i₁,i₂, . . . ,iₖ) and at least one output position;
(c) said plurality of diffused starting positions comprise a starting position (i) and an ending position (j);
(d) outputting a trigger signal, and said trigger signal ∈ {0,1};
(e) executing at least one dimensional diffused operation sequentially from said starting position to said ending position, and executing said step for t times, where t>0; and
(f) said output position outputs a bit.

15. The method of claim 14, wherein said diffused operation includes a diffused area, and said diffused area includes a diffused starting position, and said diffused starting position has a new value obtained by performing XOR of an original value with a trigger signal, and said starting position is used as a diffusion center, and a diffusion is performed sequentially outward, and a new value generated in said diffused area is a new value obtained by performing an XOR of an original value of said position with a new value at an internal adjacent position, until the diffusion of the whole diffused area is completed.

16. The method of claim 14, wherein said diffused operation includes a diffused area, and said diffused area includes a diffused starting position, and said starting position is used as a diffusion center, and a diffusion is performed sequentially inward, and a new value generated in said diffused area is a new value obtained by performing an XOR of an original value of said position with an original value at an internal adjacent position, until the diffusion of the whole diffused area is completed, and the new value of said diffused starting position is obtained by performing an XOR for said original value and said trigger signal.

17. The method of claim 14, wherein said password is inputted directly into said diffused area S.

18. The method of claim 1, wherein said diffusion module is operated once each time when said password inputs a bit.

19. A symmetric stream encryption/decryption apparatus, comprising:
an input end, for inputting a password;
an output end, for performing an XOR for said output bit and a plaintext stream bit;
a diffusion mechanism element, being a hardware design for executing said diffusion mechanism; and
a start switch, for starting at least one diffusion mechanism element.

20. The apparatus of claim 19, wherein said diffusion mechanism element has a plurality of combinations, and said combination defines a connecting method.

21. The apparatus of claim 20, wherein said connecting method is a parallel connection, and said connection is provided for said switch to sequentially start said diffusion mechanism element of said combination.

22. The apparatus of claim 20, wherein said connecting method is a parallel connection, and said connection is provided for said start switch to simultaneously start said diffusion mechanism element of said combination.

23. The apparatus of claim 19, wherein said diffusion mechanism element comprises:
an input end, for inputting a trigger signal;
an output end, for outputting a trigger signal;
a start end, for connecting a start switch; and
a diffusion function element, being a hardware design for executing said diffusion function.

24. The apparatus of claim 23, wherein said diffusion function element comprises:
a F unit, being a hardware design of said diffusion function F;
a S register, for storing a Sₜ value of said F operation;
a T register, for storing a Tₜ of said F operation;
an ⊕ unit, being a hardware design for executing an XOR operation; and
a T₀ unit, being a hardware design for initializing a trigger area.

25. The apparatus of claim 24, wherein said diffusion function F is a linear function set of at least one position of said S register, and said linear function of said position is an XOR equivalent circuit of at least one position.

26. The apparatus of claim 24, wherein said S register has a stored value of said F operation equal to Sₜ=Sₜ₋₁(F), t>0.

27. The apparatus of claim 24, wherein said S register has a stored value of said F operation equal to Tₜ=Tₜ₋₁(F)⊕T₀, t>0.

28. The apparatus of claim 27, wherein said S register has a stored value of said F operation equal to Sₜ=Sₜ₋₁(F)⊕T₁, t>0.

29. The apparatus of claim 24, wherein said To unit is an equivalent circuit of T₀=0.

30. The apparatus of claim 24, wherein said To unit is an equivalent circuit of T₀=Tₜ₋₁(F), t>0.
